(19) United States
(12) Patent Application Publication
(10) Pub. No.: US 2005/0010803 A1
(43) Pub. Date: Jan. 13, 2005

(54) Method and system for safe calculation and data transmission

(76) Inventor: Marc Michael Groz, Stamford, CT (US)

Correspondence Address: MARC M GROZ, Apt S-1602, 1450 Washington Blvd, Stamford, CT, 06902, US

(21) Appl. No.: 10/736,464

(22) Filed: Dec. 14, 2003

Related U.S. Application Data
(60) Provisional application No. 60/433,200, filed on Dec. 14, 2002.

(51) Int. Cl. H04L 9/00

(52) U.S. Cl. 713/200

(57) ABSTRACT

A method and system is disclosed for safe calculation and data transmission. The method and system addresses the problems-that-arise when calculations must be performed using data that is too sensitive to be seen by others. Applications of the method and system include trading, portfolio management, risk management, auctions, and testing of sensitive military or government data.

### CROSS REFERENCE TO RELATED APPLICATION

This application claims benefit of U.S. Provisional Patent Application No. 60/433,200, filed Dec. 14, 2002, which is hereby incorporated by reference.

### BACKGROUND OF THE INVENTION

There are many instances in which commerce and/or other valuable activities are inhibited by the reluctance of one or more parties to show information. Despite the wide availability of encryption, information may become vulnerable whenever it is decrypted for processing purposes. For example, during an auction, when one or more potential buyers submits one or more bids on one or more items, said potential buyers may wish to safeguard information about the amounts, number, and timing of their bids. Winners may wish to reveal only the minimum information necessary to complete transactions. Depending upon the type of auction, said minimum may be that said winners were the highest bidders for their respective winning transactions.

Sometimes, said reluctance to share information may be overcome by the introduction of one or more parties (“honest brokers”) whose role is to act as neutral intermediaries among a plurality of other parties. Even with the addition of one or more honest brokers, however, there may still be circumstances in which the information is of such great value as to inhibit said activities. To illustrate, consider what happens when a professional money manager wishes to unload a large block of stock. Traditionally, said money manager might have attempted to move into the market slowly, testing the waters with small sales divided up amongst many brokers. This strategy may have worked sometimes, but other times may have led to large opportunity costs as news got out that a large amount of a particular stock was being sold. As an alternative, some money managers have turned to automated systems that match up buyers and sellers. Said systems may protect the anonymity of said buyers and sellers, and may also promise to keep confidential some or all of the information provided by said buyers and sellers to said system. Nonetheless, said system, and the parties responsible for it, remain a point of potential vulnerability and information leakage, either from inadequate system security, malicious insiders, malicious hackers, computer viruses, or other rogue programs.

Cases such as these, along with many other situations involving sensitive scientific, commercial, or government data, suggest a need for a method and system for safe calculation and data transmission.

### BRIEF DESCRIPTION OF THE INVENTION

As noted above, what is needed is a safer way to share information that may need processing without negative consequences to the information provider. The present invention provides such a mechanism.

We may define an Isomorphism Server (“IsoServer”) as an active software/system component or module, which may be linked to one or more physical devices. Said IsoServer may reside or otherwise be associated with computer and related hardware which may include without limitation:
electronic computers
optical computers
biological computers
quantum computers capable of operating with qubits and entangled states.

In a preferred embodiment, an IsoServer may be implemented as an internet/web agent, i.e., as a persistent, active software/system component with the capacity to communicate, perceive, reason, and act within its environment. The environment of said IsoServer may include one or more computer and/or communications networks including public networks, private networks, and the internet. Said environment may also include the physical environment of one or more physical devices to which said IsoServer may be linked. Said IsoServer may interact with other internet/web agents and with other physical devices.

An IsoServer may be represented abstractly as
I(x₁, . . . , xₙ), where x₁, . . . xₙ are inputs and/or state variables of IsoServer I.

### BRIEF DESCRIPTION OF THE DRAWINGS

The above summary of the invention will be better understood when taken in conjunction with the following detailed description and accompanying drawing in which:

FIG. 1 is a block diagram of an architecture suitable for implementing the present method and system.

### DETAILED DESCRIPTION OF THE INVENTION

IsoServers facilitate safe calculations by exchanging information with other entities, which we shall designate IsoClients. IsoClients may (for example and without limitation) include people, programs, internet agents, web agents, robots, machines, software devices, firmware devices, hardware devices, electronic computers, biological computers, optical computers, quantum computers, or combinations thereof.

One or more IsoClients may issue a request for service to one or more IsoServers. Alternatively, one or more IsoServers may initiate an interaction by offering services to one or more IsoClients. Said offer may be based upon information about said IsoClients that is or becomes available to said IsoServers.

In either case, once said IsoServers and IsoClients are in communication, one or more of said IsoClients may request one or more specific services from one or more IsoServers. Said services may include provision by said IsoServers of Isomorphism Programs (IsoProgs) to said IsoClients.

An IsoProg is a program that implements a mathematical function that preserves one or more relationships among a plurality of data sets. Said IsoProg is used to create IsoData upon which additional calculations may be safely performed by one or more parties with whom IsoClients do not wish to share their unprotected data (“Raw Data”).

As described in what follows, the method and system use IsoProgs obtained by IsoClients from IsoServers to create IsoData from Raw Data. Said IsoData may be processed by parties who never get access to said Raw Data or said IsoProg. We shall call said parties minimum information clients (“MinClients”). IsoData received by said MinClients may be transformed by an allowed class of other programs (“HeteroProgs”) by one or more MinClients and/or IsoClients. In a preferred embodiment, said HeteroProgs may change Initial IsoData directly into a final data set, referred to as Final IsoData. After the creation of said Final IsoData, it may be transmitted to one or more IsoServers and/or IsoClients for conversion back into an undisguised form of data called Final Data using the inverse function of the IsoProg (“InvIsoProg”). Said Final Data is identical to the outcome that would have been obtained by the MinClient if it had been given access to the Raw Data.

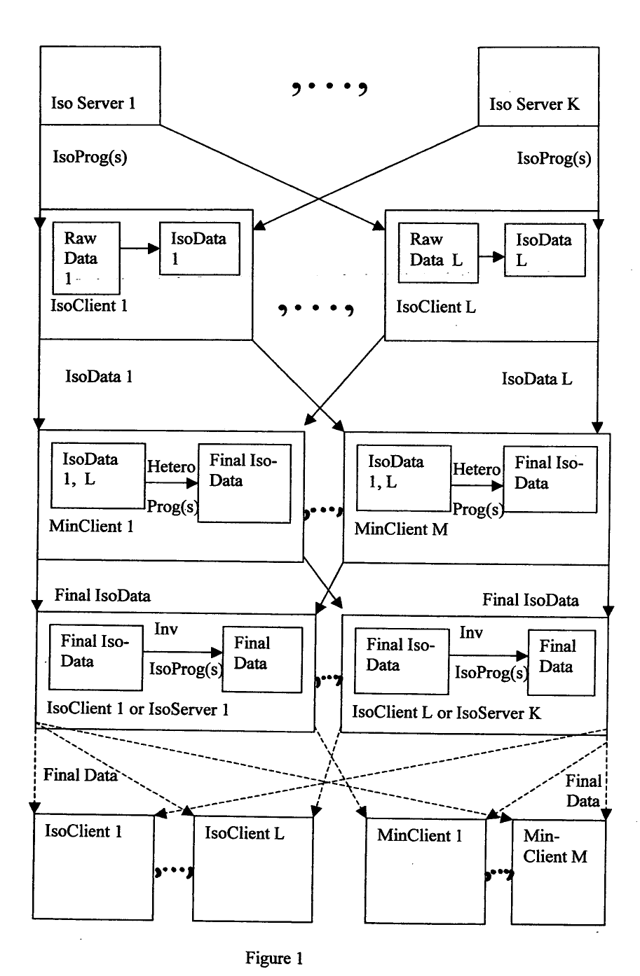

A suitable architecture for implementing the present method and system is shown in FIG. 1. As shown in FIG. 1, the architecture comprises one or more IsoServers (row label 1) sending one or more IsoProgs (row label 2) to one or more IsoClients (row label 3). As shown in row 3, said IsoClients use said IsoProgs to transform one or more collections of Raw Data into one or more collections on IsoData. In row 4, this IsoData is transmitted to one or more MinClients (row 5). In row 5, said MinClients operate on said IsoData with one or more HeteroProgs to generate one or more collections of FinalIsoData. In row 6, said FinalIsoData is sent to one or more IsoServers and/or IsoClients (row 7) where one or more InvIsoProg converts FinalIsoData into FinalData.

In row 8, said Final Data is transmitted from said IsoServers and/or IsoClients to one or more IsoClients and/or MinClients (row 9).

In an alternative preferred embodiment, said HeteroProgs may change Initial IsoData into one or more collections of Intermediate IsoData before changing the last collection of Intermediate IsoData into a final data set, referred to as Final IsoData. After the creation of said Final IsoData, it may be transmitted to one or more IsoServers and/or IsoClients for conversion back into an undisguised form of data called Final Data using the inverse function of the IsoProg (“InvIsoProg”). Said Final Data is identical to the outcome that would have been obtained by the MinClient if it had been given access to the Raw Data.

In another alternative preferred embodiment, IsoServers transmit both IsoProgs and InvIsoProgs to IsoClients. MinClients transmit said Final IsoData directly to said IsoClients which apply InvIsoProgs to the FinalIsoData to create FinalData.

Definition. We say that a function F preserves a relationship R among data sets D1, . . . , DN if
R(D, . . . , DN) if and only if R(F(D1), . . . ,F(DN))
Examples of IsoProgs.

1. A program that implements the function
F(x)=2x³+7x+100
(without rounding error) preserves the dyadic relationships of ‘<’, ‘=’, and ‘>’ among a plurality of binary data sets whose members (the values allowed for x) are positive integers.

2. A program that implements the function
F(x)=−x
Preserves relationships among real data sets that ignore the sign of the number x.

3. A program that implements the function
F(x)=ax,
where a is a positive scalar.

F is an example of a function that preserves relationships among vector data sets that do not depend upon the magnitude of the vector x. Said relationships include angle of separation between paired vectors, which may be considered a vector quotient (quaternion). More generally, measures of correlation among data sets are insensitive to multiplication by a positive scalar.

4. A program that operates on character strings C=c₁, . . . , cₙ by prepending a fixed character string P=p₁, . . . , pₜ before C,
where each pⱼ, cᵢ ε A={a₁, . . . , aₘ}.

A is a finite ordered set (called an alphabet). Said program preserves the ordering relation defined by said alphabet.

5. A program that operates on character strings C=c₁, . . ., cₙ by inserting a fixed character string I=i₁, . . . , iₜ inside C,
where each iⱼ, cᵢ ε A={a₁, . . . , aₘ}.

A is a finite ordered set (called an alphabet). Said program preserves the ordering relation defined by said alphabet.

6. A program that operates on character strings C=c₁, . . . , cₙ by appending a fixed character strings A=a₁, . . . , aₜ after C,
where each aⱼ, cᵢ ε A={a₁, . . . aₘ}.

A is a finite ordered set (called an alphabet). Said program preserves the ordering relation defined by said alphabet.

In a preferred embodiment, the mathematical function is treated as a black box and its contents are never revealed. The associated program code is encrypted during transmission to prevent possible misuse by third parties.)

### EXAMPLES

1. Consider a plurality of parties bidding for an item at auction on a computer network. The winner is the highest bidder at the end of the (single round) auction—there is no reserve price. The minimum bid is $1. The highest bidder pays the mean of the two highest bids. All bidders would prefer that their bid information be protected.

In a preferred embodiment, the auction provider facilitates bidder privacy by allowing bidders to submit IsoBids. Said bidders may submit IsoBids (as defined below) in the following manner: they receive a preferably encrypted IsoProg from an IsoServer. Said IsoProg may execute a linear transformation defined on positive integers; for purposes of example, let's say the function is
F(x)=5x+1000

Said linear transform function preserves the order relation among bids, while disguising their exact relative magnitudes and ratios. Instead of submitting their undisguised bids to the auction, said bidders submit their bids as modified by the IsoProg—we shall call such bids IsoBids.

Continuing the example, if there are three bidders B1, B2, B3, bidding $100, $200, and $300 respectively, then the IsoBids for these bidders are 1500, 2000, and 2500. These are the numbers seen by the auction provider (which may be, for example and without limitation, a computer or a person receiving said IsoBids via electronic mail and performing calculations in a spreadsheet). The auction provider may take an average of the two top bidders IsoBids ((2000+2500)/2=2250), even though said auction provider does not know the true magnitude or even the ratio between the top bidders. This number and the identity of the winner may be transmitted to the IsoServer that may supply an inverse IsoProg that turns the supplied number into the correct amount to be paid by the winning bidder. Continuing the example, the IsoServer executes a program that calculates the inverse linear function
F⁻¹(y)=(y−1000)/5

Which, for y=2250, yields an answer of $250, which is the correct mean of the two highest bids.

2. Consider a highly sensitive commercial, military, or government secret which may include Raw Data sets whose values must not be known to competitors enemies, or rivals. Suppose that said Raw Data sets is tested by an algorithm T, which compares each of the sets against all of the others to determine which set has the largest single element and which set has the smallest single element. These results may be calculated in a fashion similar to the previous example, using an IsoServer to provide an IsoProg that preserves the order relationships among the Data Sets.

3. Consider data relating to polling studies before an election. The method may be used for statistical analysis of data that protects the Raw Data from interception and leakage to rivals or the media.

IsoServers for safe negotiation and deal-making. In a preferred embodiment, IsoServers may be programmable internet/web agents (preferably linked to physical devices) that scour one or more computer networks (and preferably the physical environment of linked physical devices) for clients. Said IsoServers may link up with other IsoServers to create one or more pools of IsoServers (“P-IsoServers”). Said IsoServers and/or P-IsoServers may negotiate with other web agents (and preferably physical devices) to provide one or more IsoProgs to one or more clients. Said IsoProgs may preferably perform market analysis, risk management, and/or record-keeping functions and/or communicate transactional and/or other information to other agents or facilities. Transactions may result in changes to the internal state of one or more said IsoProgs or to changes in the ownership and/or custody arrangements of one or more financial instruments. Other web agents (and preferably physical devices) representing actual or potential buyers, sellers, or third parties such as regulators and/or service providers, may negotiate and transact with said IsoServers and/or P-IsoServers.

Use of multiple IsoServers and IsoProgs for error correction and/or enhanced security. In a preferred embodiment, a single IsoServer supplying a single IsoProg to one or more IsoClients may provide sufficient safety and accuracy, preferably supplemented by standard commercial or public domain software programs for verifying the integrity of said IsoProg.

In an alternative preferred embodiment, multiple IsoServers may supply copies of said IsoProg to one or more clients for purposes of error detection and correction. In such case, a plurality of calculations may be performed by one or more clients. Said clients may examine the results of said calculation for consistency.

In another preferred embodiment, a plurality of calculations may be performed by one or more clients using a plurality of IsoProgs on their data to create a plurality of IsoData sets. Said IsoData may be transmitted to one or more IsoServers or P-IsoServers that may implement appropriate reverse functions to check for calculation consistency. Said IsoServers or P-IsoServers my report the outcomes of said calculations to said clients.

[Note: The above-described application may create P-IsoServers that may assemble themselves into one or more redundant, error-correcting IsoServers, allowing said error-correcting IsoServers to help manage negotiations, trade, analyze markets, manage risk, keep records—subject to constraints imposed by the program, other agents, and the environment. The inclusion of physical devices allows human traders, analysts, risk managers, portfolio managers, and others to enter and interact in this environment with human and computer counterparts all over the world-both in physical and virtual space.]

While the invention has been described in conjunction with specific embodiments, it is evident that numerous alternatives, modifications, and variations will be apparent to those skilled in the art in light of the foregoing description.

1. A method for performing calculations and transmitting data safely, said method comprising:
Selecting one or more IsoServers;
Selecting one or more IsoClients, said IsoClients exchanging data and receiving one or more IsoProgs from said IsoServers;
Applying said IsoProgs to one or more collections of RawData to generate one or more collections of IsoData;
Transmitting one or more collections of IsoData to one or more MinClients;
Applying one or more HeteroProgs to one or more collections of IsoData to generate one or more collections of Final IsoData;
Transmitting one or more collections of FinalIsoData to one or more IsoServers and IsoClients;
Applying one or more InvIsoProgs to one or more collections of FinalIsoData to generate one or more collections of Final Data.

2. The method of claim 1, where one or more said IsoServers initiate the exchange of data with one or more of said IsoClients.

3. The method of claim 1, where one ore more said IsoClients initiate the exchange of data with one or more of said IsoServers.

4. The method of claim 1, where one or more said MinClients initiate one or more requests for one or more collections of said IsoData from one or more of said IsoClients.

5. The method of claim 1, where one or more said IsoClients initiate one or more offers to send one or more collections of said IsoData to one or more of said MinClients.

6. The method of claim 1, where no more than one of said HeteroProgs is applied to any of said collections of IsoData.

7. The method of claim 1, where a multiplicity of said HeteroProgs is applied to one or more of said collections of IsoData.

8. The method of claim 1, where one or more collections of said Final IsoData is transmitted to one or more of said IsoServers.

9. The method of claim 1, where one or more collections of said Final IsoData is transmitted to one or more of said -IsoClients.

10. The method of claim 1, where said InvIsoProgs are applied to one or more collections of said Final IsoData by one or -more of said IsoServers.

11. The method of claim 1, where said InvIsoProgs are applied to one or more collections of said Final IsoData by one or more of said IsoClients.

12. The method of claim 1, where one or more of said IsoServers is an internet/web agent.

13. The method of claim 12, where said internet/web agents link up to form one or more P-IsoServers.

14. The method of claim 13, where said IsoServers and P-IsoServers negotiate with counterparties.

15. The method of claim 14, where said counterparties are internet/web agents.

16. The method of claim 14, where said counterparties are physical devices.

17. The method of claim 13, where IsoProgs running on said internet/web agents perform market analysis.

18. The method of claim 13, where IsoProgs running on said internet/web agents communicate transactional information to other agents and/or facilities.

19. The method of claim 1, where a multiplicity of IsoProgs is used to facilitate error correction.

20. The method of claim 1, where a multiplicity of IsoServers is used to facilitate error correction.

21. The method of claim 1, where one or more of said IsoProgs preserves the dyadic relationships of ‘<’, ‘=’, and ‘>’.

22. The method of claim 1, where one or more of said IsoProgs preserves relationships among vector data sets that do not depend upon magnitude.

23. The method of claim 22, where one or more of said IsoProgs preserves the pairwise vector quotients of said -vector data sets.

24. The method of claim 1, where said IsoClients use said IsoProgs to create IsoBids.

25. The method of claim 24, where said IsoBids are used in an auction.

26. The method of claim 25, where said auction is conducted over a communications network.

27. The method of claim 26, where said communications network consists of one or more computer networks.

28. The method of claim 1, where highly sensitive data is tested by an algorithm.

29. The method of claim 28, where said data relates to military or other government secrets.

30. A system for performing calculations and transmitting data safely, said system comprising:
a means for selecting one or more IsoServers;
a means for selecting one or more IsoClients, said IsoClients exchanging data and receiving one or more IsoProgs from said IsoServers;
a means for applying said IsoProgs to one or more collections of RawData to generate one or more collections of IsoData;
a means for transmitting one or more collections of IsoData to one or more MinClients;
a means for Applying one or more HeteroProgs to one or more collections of IsoData to generate one or more collections of Final IsoData;
a means for transmitting one or more collections of FinalIsoData to one or more IsoServers and IsoClients;
a means for applying one or more InvIsoProgs to one or more collections of FinalIsoData to generate one or more collections of Final Data.
